(19) United States
(12) Patent Application Publication
(10) Pub. No.: US 2015/0243251 A1
(43) Pub. Date: Aug. 27, 2015

(54) CALIBRATION SYSTEM AND RECORDING MEDIUM FOR MULTI-DISPLAY

(71) Applicant: Sharp Kabushiki Kaisha, Osaka-shi, Osaka (JP)

(72) Inventor: Hideki Ohnishi, Osaka-shi (JP)

(73) Assignee: Sharp Kabushiki Kaisha, Osaka-shi, Osaka (JP)

(21) Appl. No.: 14/427,066

(22) PCT Filed: Sep. 6, 2013
(86) PCT No.: PCT/JP2013/074143

§ 371 Date: Mar. 10, 2015

(30) Foreign Application Priority Data
Sep. 14, 2012 (JP) 2012-203625

(51) Int. Cl. G09G 5/12

(52) U.S. Cl. CPC G09G 5/12; G09G 2320/0666

(57) ABSTRACT

The present invention includes: an input section (11) which accepts, for individual displays, first adjustment values; a calculation section (46) which corrects measurement results of colors of plural regions of each display displaying a color calibration image by using the first adjustment values inputted by the input section, obtains color differences between the adjacent displays, with correspondence to arrangement of the displays, based on measurement results of bordering regions of the displays out of the measurement results or post-correction measurement results, and then determines a maximum color difference from the color differences; a second storage section (48) which stores the maximum color difference being associated with the first adjustment values; and an adjustment section (49) which reads, from the second storage section, the first adjustment values minimizing the maximum color difference, and then set, for the individual displays, the read first adjustment values to perform color adjustment on the displays.

### TECHNICAL FIELD

The present invention relates to a calibration system for performing correction of color non-uniformity between displays (display apparatuses) included in a multi-display (a multi-screen display, a tiled display).

### BACKGROUND ART

A multi-display is configured such that a plurality of displays are arranged to be tiled together contiguously, so that an image corresponding to one image data can be shown on these displays. As technology progresses, a bezel of each display has become narrower. As such, a plurality of displays arranged on, for example, upper, lower, left, and right positions can be viewed as a single large display because bezels of the displays are not annoying.

A multi-display, which can be viewed as a single large display, has been used for various applications such as signage and amusement. The multi-display allows displaying a powerful and large image and a colorful image which cannot be displayed on only a single display.

With the increasing range of uses for the multi-display, importance has been placed on color reproduction capability and image quality of the multi-display. Further, there has been proposed a technique of securing “screen uniformity of a multi-display”. As for a multi-display, one of important measures is the development of a technique of correcting color non-uniformity between displays, which color non-uniformity occurs due to individual variations between displays of the multi-display. For example, Patent Literatures 1 and 2 disclose prior techniques for securing “screen uniformity of a multi-display.”

Patent Literature 1 discloses a technique of adjusting the multi-display so that images corresponding to bordering (adjacent) regions of screens are identical to each other. For example, in a case of a multi-display constituted by nine displays (3×3), a display located in the center is first adjusted, and its surrounding displays are then adjusted. In a case where adjustments need to be performed based on two reference displays, adjustments using their respective adjustment references are performed so as to minimize a difference between images displayed on bordering regions of the displays.

Patent Literature 2 discloses a technique of, in a multi-vision system using a plurality of projectors, correcting color non-uniformities of the projectors. First, on the projectors being arranged, test signals in red, green, blue, and black are displayed. Then, displayed colors shown on the projectors are detected by a sensor, and color information obtained by the detection is determined as a XYZ tristimulus value. Subsequently, a total sum of differences between four colors of the adjacent projectors and their corresponding displayed colors at the four corners is obtained. On the basis of the obtained total sum, the arrangement of the projectors which arrangement provides a minimum color difference is determined. For the projectors arranged in the determined optimum arrangement, calibration values of the projectors are sequentially determined, based on a reference projector positioned in the middle of the arranged projectors, so that colors identical to the four displayed colors can be obtained for the projectors around the reference projector.

### CITATION LIST

### Patent Literature

Patent Literature 1:
Japanese Patent Application Publication, Tokukai No. 2001-92431

Patent Literature 2:
Japanese Patent Application Publication, Tokukai No. 2000-59806

### SUMMARY OF INVENTION

### Technical Problem

However, the conventional techniques as described earlier have the following problems.

Patent Literature 1 discloses that in case of a four-screen configuration in which, for example, displays are arranged in a vertical direction and a horizontal direction (four types of displays of A to D are arranged clockwise), although boundary parts between a display A and a display B, a display B and a display C, and a display C and a display D can be undistinguishable, a difference in a boundary part between a display D and a display A is large. Accordingly, it is necessary to find a condition in which the difference becomes small by repeating the above process to adjust brightness and a color shade of the whole multi-display. That is, a large quantity of time is required to adjust the whole multi-display.

Patent Literature 2 discloses a technique of the multi-vision system using projectors. Application of the multi-vision system to the multi-display requires relocation of displays. However, the multi-display is configured such that, in many cases, once displays are positioned, the displays are difficult to be relocated although it is preferable if there is a multi-display in which the relocation of displays can be simply made. Further, even if there exist the multi-display in which the displays can be simply relocated, relocation of displays is required each time if display colors of displays are deteriorated by an elapse of time.

The present invention has been made in view of the above problems, and an object of the present invention is to provide a calibration system by which calibration on color of a multi-display easily carrying out in a short time.

### Solution to Problem

In order to solve the above problem, a calibration system for a multi-display in accordance with one aspect of the present invention is a calibration system for a multi-display, the calibration system being a calibration system for performing color adjustment on each of a plurality of displays constituting the multi-display, the calibration system including: a display image generation section configured to generate a color calibration image for calibrating a color of each of the displays; a first storage section configured to store therein measurement results, the measurement results being results of measurements of colors of a plurality of regions of each of the displays on which the color calibration image generated by the display image generation section is being displayed; an input section configured to accept, for the individual displays, color first adjustment values (first color adjustment values) corresponding to the respective displays; a correction section configured to read, from the first storage section, the measurement results of the displays, and then correct the read measurement results with use of the corresponding color first adjustment values inputted by the input section; a calculation section configured to obtain color differences between the displays adjacent to each other, with correspondence to an arrangement of the displays, on a basis of measurement results of bordering regions of the displays out of the measurement results stored in the first storage section or out of, if any, post-correction measurement results obtained by correction performed by the correction section, and then determine a maximum color difference from the obtained color differences; a second storage section configured to store therein the maximum color difference determined by the calculation section in such a manner that the maximum color difference is associated with the corresponding first adjustment values used for the correction performed by the correction section; and an adjustment section configured to read, from the second storage section, the first adjustment values which minimize the maximum color difference, and then set, for the individual displays, the read first adjustment values to perform color adjustment on the displays.

### Advantageous Effects of Invention

One aspect of the present invention yields an effect of easily carrying out calibration on color of a multi-display in a short time.

### BRIEF DESCRIPTION OF DRAWINGS

FIG. 1 is a block diagram illustrating a configuration of a calibration system for a multi-display in accordance with an embodiment of the present invention.

FIG. 2 (a) to (d) of FIG. 2 are diagrams illustrating examples of measurement positions at which colors are measured by a color-measurement device.

FIG. 3 is a diagram illustrating a process in which a calculation section of a system control section included in the calibration system illustrated in FIG. 1 performs calculation based on measurement results to obtain color differences and a maximum color difference.

FIG. 4 is a diagram illustrating a process in which the calculation section of the system control section included in the calibration system illustrated in FIG. 1 corrects measurement results on the basis of an inputted adjustment value and then obtains color differences and a maximum color difference by calculation on the basis of corrected measurement results.

FIG. 5 is a diagram illustrating an example of an image shown on a display section of the system control section included in the calibration system illustrated in FIG. 1 in a situation where the number of displays is larger than 2×2, the image including (i) measurement results of the displays, (ii) color differences and a maximum color difference both of which are calculated on the basis of the measurement results, and (iii) adjustment values of the displays.

FIG. 6 is a diagram illustrating a process in which the calculation section of the system control section included in the calibration system illustrated in FIG. 1 corrects measurement results on the basis of the inputted adjustment value, and then obtains color differences and a maximum color difference by calculation, on the basis of the post-correction measurement results, in a state that weighing for the color differences at edge portions of a multi-display is done.

FIG. 7 is a diagram illustrating a matrix including representative values of 729 colors (9×9×9), wherein the 729 points are obtained by any varying combinations of nine types of values {0, 32, 64, 96, 128, 160, 192, 224, 255} selected for each R, G, B.

FIG. 8 (a) and (b) of FIG. 8 are diagrams each illustrating a lookup table showing a relationship between RGB values and XYZ values.

FIG. 9 is a diagram illustrating one block of the matrix, illustrated in FIG. 7, including the representative values of 729 colors.

FIG. 10 (a) to (c) of FIG. 10 are diagrams illustrating one block of the matrix, illustrated in FIG. 7, including the representative values of 729 colors.

FIG. 11 is a block diagram illustrating a calibration processing section established by the system control section illustrated in FIG. 1.

FIG. 12 is a flow chart showing a procedure to perform a manual calibration process.

### DESCRIPTION OF EMBODIMENTS

The following description details embodiments of the present invention.

### (Measurement Position of Color)

Displays are usually adjusted so that hue, color uniformity, etc. fall within a certain range which is not distinguishable by human's eyes. Therefore, each of the displays has a difference to a certain extent (difference caused by characteristics of displays). The difference caused by the characteristics of the displays is rarely a problem when the displays are individually used as a single display for displaying. However, the difference caused by the characteristics of the displays is noticeable in a multi-display in which a plurality of displays are arranged to be tiled together contiguously.

For example, in a configuration where slightly yellow tint display and a slightly blue tint display are arranged adjacent to each other, a difference in image appearance between these displays is noticeable at their bordering portions even though the difference is not problem when the displays are individually used as a single display. The difference can be made less noticeable by performing, on each display, correction of color appearance characteristics (hereinafter also referred to as color adjustment) by using a function of independently adjusting a red (R) component, a green (G) component, and a blue (B) component (contrast adjustment and the like) of each display. In a case where two displays are used, a color of one of the two displays may be adjusted so that the color conforms to that of another display.

Meanwhile, in the case where a multi-display is configured such that one display is surrounded by other displays, i.e., other displays are provided on a left side, a right side, and an upper side, and a lower side of the one display, there may occur a problem that an image shown on the display on the left side is yellow tinted, an image shown on the display on the right side is red tinted, an image shown on the display on the upper side is green tinted, and an image shown on the display on the lower side may be blue tinted. In this case, such a problem cannot be handled by color adjustment of only a single display out of the displays, and instead, color adjustment has to be made on the displays as a whole. In other words, a plurality of displays have to be subjected to measurement.

Further, with an increase in size of a display, a slight difference (difference in hue) which is not noticeable by human's eyes occurs, even on a same plane of a single display, from one place to another in upper, lower, left, right portions, and the like portions of the display. As described earlier, such a difference may be noticeable when there is a difference in hue between corresponding portions of the displays adjacent to each other. Therefore, a plurality of points of the displays have to be measured with a color-measurement device because a measurement of only a middle point of each of the displays is insufficient.

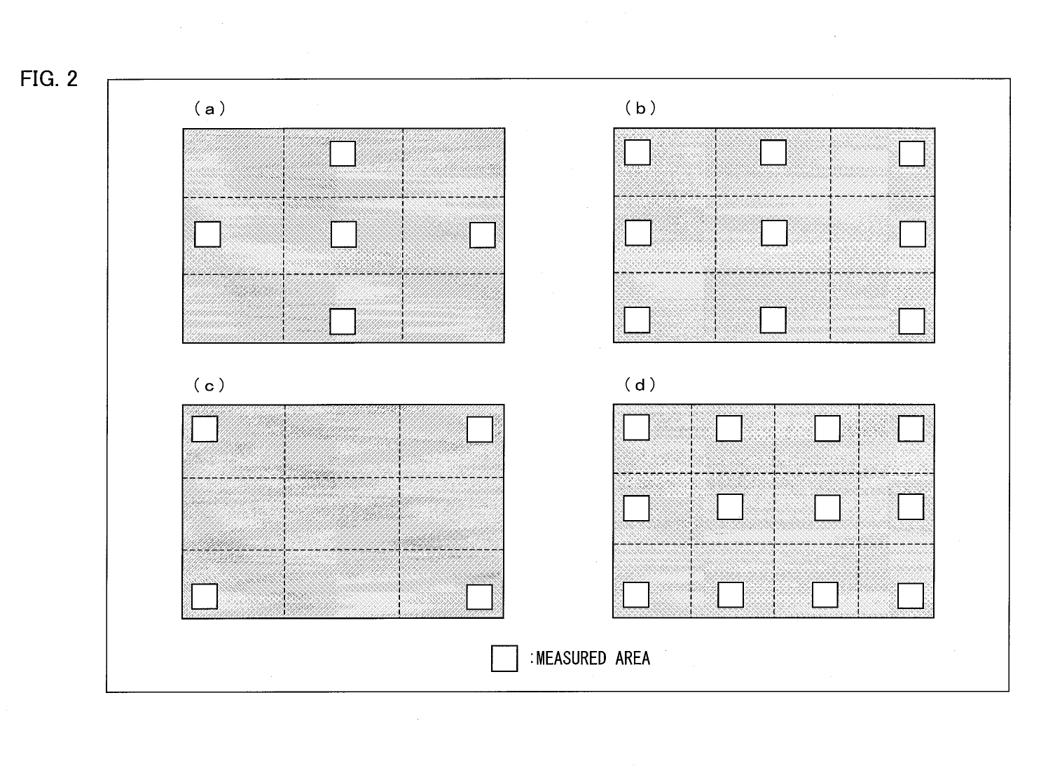

(a) to (d) of FIG. 2 illustrate examples of measurement positions. As illustrated in (a) of FIG. 2, points subject to the measurement are at least four points which are an upper point, a lower point, a left point, and a right point, or five points which are obtained by adding a middle point to the four points. If possible, the points subject to the measurement are preferably nine points in total (an uppermost left point, a middle left point, a lower left point, an uppermost middle point, a center point, a lower middle point, an uppermost right point, a middle right point, and a lower right point), wherein the nine points are obtained by dividing the display into three both in a vertical direction and in a horizontal direction, as illustrated in (b) of FIG. 2. Alternatively, only especially concerned points may be measured as illustrated in (c) of FIG. 2. Further alternatively, a display may be divided into more than nine as illustrated in (d) of FIG. 2.

### (Measurement Results of the Displays and RGB Adjustment Method)

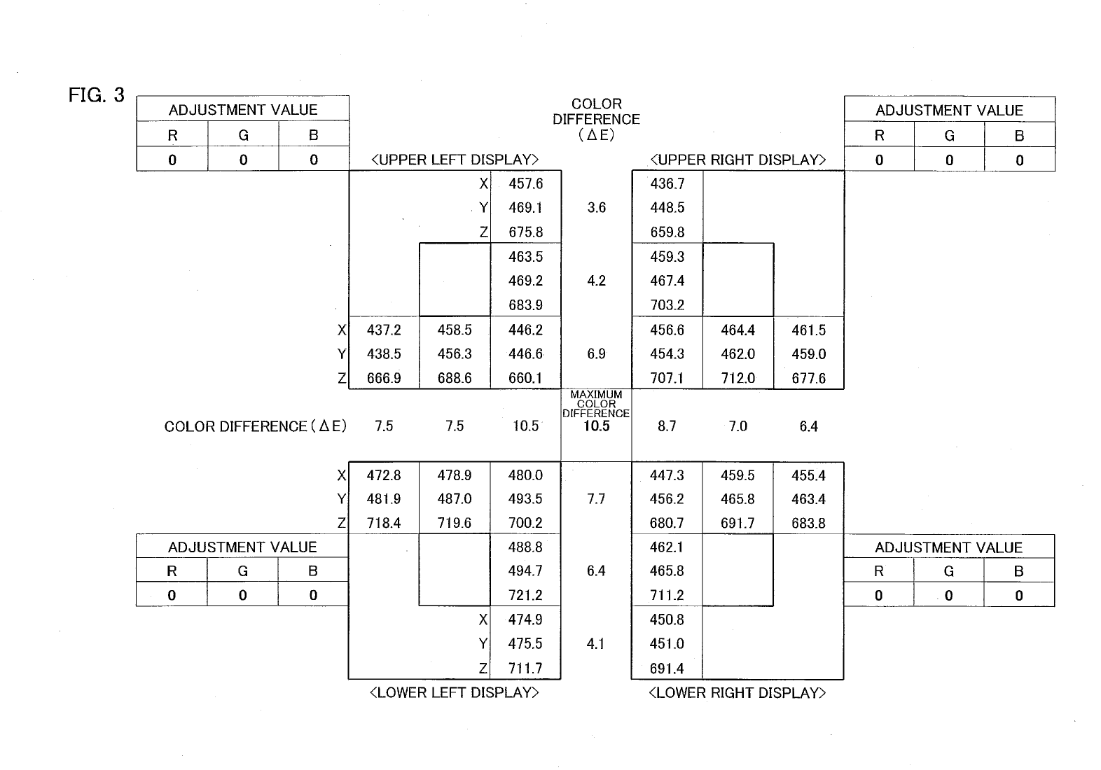

FIG. 3 shows, as one example, measurement results (XYZ values: tristimulus values) obtained by the color-measurement device when each plane of four displays (two rows by two columns) is divided into three both in a vertical direction and in a horizontal direction to obtain nine portions in total (see (b) of FIG. 2). The example of FIG. 3 shows measurement results of only bordering portions of the displays although nine portions for each display are measured practically. However, nine portions for each display do not necessarily have to be measured. If the number of displays is large and a rough adjustment is good enough, out of nine portions, five portions which are a center portion, and portions at an upper side, a lower side, a left side, and a right side (see (a) of FIG. 2) can be measured.

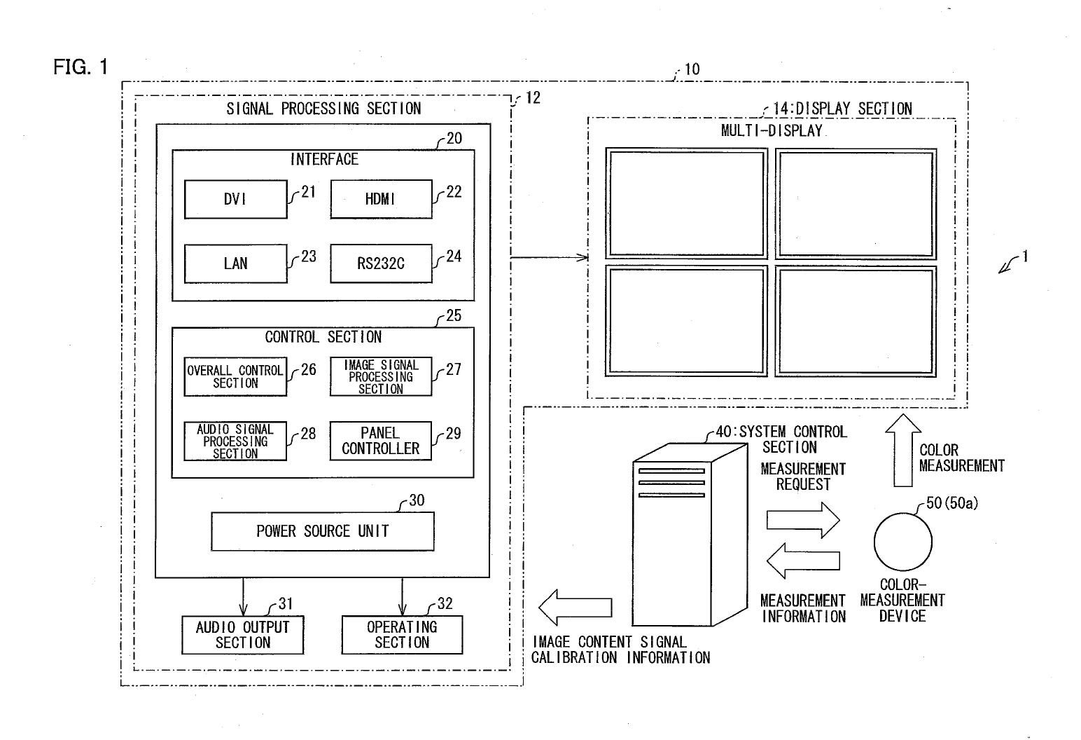

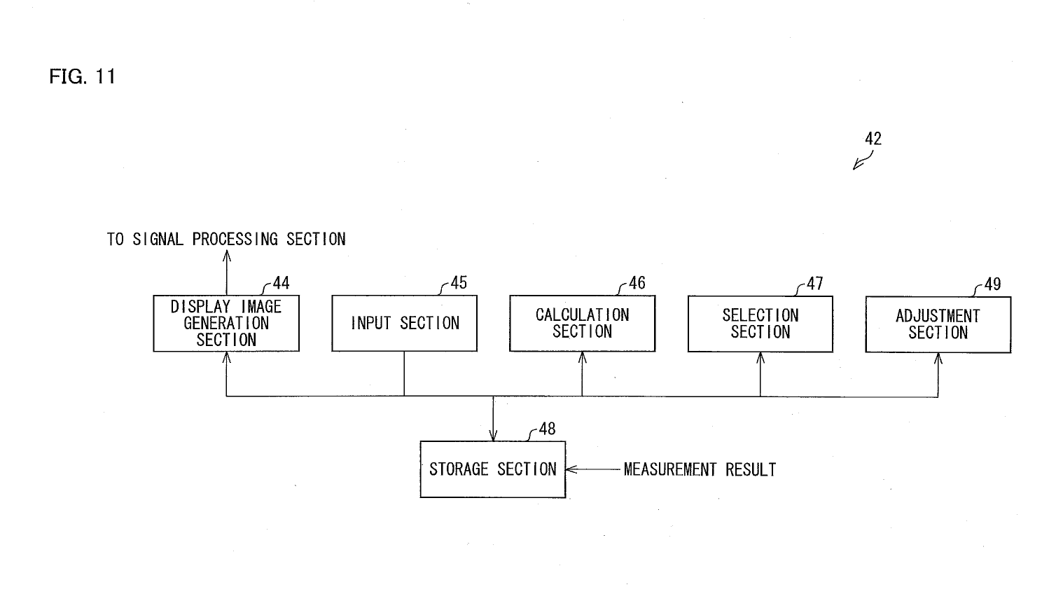

Note that FIG. 3 is a diagram illustrating a process in which a calculation section 46 (see FIG. 11) of a system control section 40 (see FIG. 1), which will be described later, performs calculation based on measurement results to obtain color differences and a maximum color difference. In a case where calibration is automatically performed, an image illustrated in FIG. 3 is not displayed. Alternatively, in a case where calibration is manually performed, it is preferable that an image similar to the image illustrated in FIG. 3 is displayed on a display section of the system control section 40 (see FIG. 1), which will be described later, in order to facilitate an operation.

Although the measurement results of the bordering portions of the displays are indicated by XYZ values in FIG. 3, the measurement results are expressed, for display, as differences in hue, in other words, as hues (red tint, blue tint, yellow tint, green tint, and orange tint) which indicate how much deviation is caused from a color to be adjusted (e.g. white or the like), in order to easily find the presence or absence of color non-uniformity. The display section of the system control section 40 may be a single display out of a plurality of displays constituting a multi-display subject to calibration.

Each of the measurement results is indicated by X, value Y, value, and Z value in this order from the top in FIG. 3, and an adjustment value (first adjustment value) inputted for adjusting each display is a RGB value.

In the present embodiment, the measurement result obtained by the color-measurement device is expressed as XYZ of an XYZ colorimetric system which is a device independent color space, and an adjustment value for adjusting the display is inputted by an RGB. The measurement result obtained with the color-measurement device can be displayed with any color space, as long as the device independent color space. For example, for the measurement result, values of CIE1976L*a*b* (CIE: Commission Internationale de l'Eclairage, L*: brightness, a*/b*: chromaticity) colorimetric system (color space) and CIE1976L*u*v* (L*: brightness, u*/v*: chromaticity) colorimetric system, and the like may be used.

Further, FIG. 3 indicates, in a space between the displays, a color difference (ΔE) obtained based on measurement values of bordering portions of the displays, and indicates a maximum color difference in a center space surrounded by the four displays. In this arrangement, a color difference between a lower right portion of an upper left display and an upper right portion of a lower left display is 10.5, which is a maximum value among all of the color differences. Therefore, a maximum color difference is indicated as 10.5 in the center space surrounded by the four displays. In this example, adjustment values of RGB are all zero because no color adjustments are made.

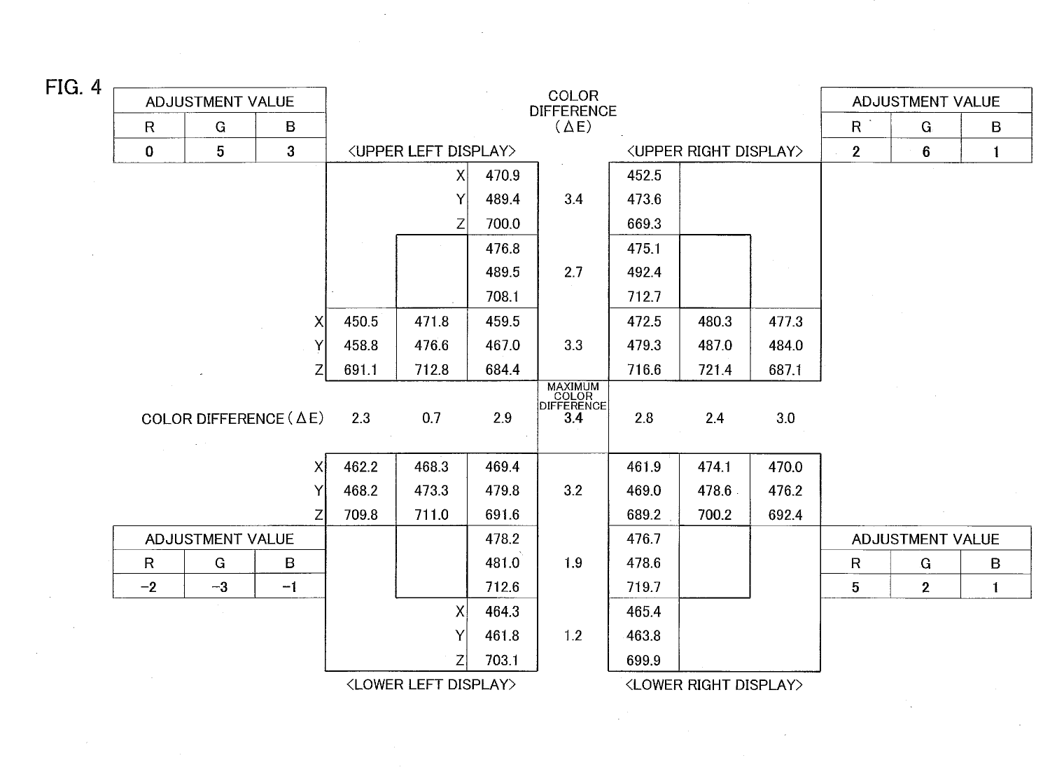

FIG. 4 shows a method of performing adjustments with respect to measurement results of each display in FIG. 3. FIG. 4 is a diagram illustrating a process in which the calculation section 46 (see FIG. 11) of the system control section 40 (see FIG. 1), which will be described later, corrects measurement results on the basis of an inputted adjustment value and then obtains color differences and a maximum color difference by calculation on the basis of corrected measurement results.

The system control section 40 obtains a XYZ value (ΔXYZ values) which changes with respect to a RGB adjustment value (ΔRGB), by using Formula 1 (a transformation matrix) below. Next, the system control section 40 adds the obtained XYZ value to values of all of the separate regions of a corresponding display so as to obtain new XYZ values. In a manual operation, a user manually inputs the RGB adjustment value. In an automatic operation, the system control section 40 inputs a predetermined value as the adjustment value. The transformation matrix is described later.

$$\begin{matrix}[ Math . 1 ] & \\ ( \begin{matrix}Δ X \\ Δ Y \\ Δ Z\end{matrix} ) = ( \begin{matrix}a & b & c \\ d & e & f \\ g & h & i\end{matrix} ) \cdot ( \begin{matrix}Δ R \\ Δ G \\ Δ B\end{matrix} ) & Formula 1\end{matrix}$$

After obtaining new XYZ values, the system control section 40 recalculates color differences of regions corresponding to the bordering portions of the displays, and then obtains a maximum color difference. The system control section 40 causes the obtained maximum color difference to be displayed in an easily recognizable space, which is a center space surrounded by the displays. In an example of FIG. 4, a color difference between an upper right portion of an upper left display and an upper left portion of an upper right display is 3.4 which is a maximum color difference. Therefore, the value of the maximum color difference is indicated in the center space.

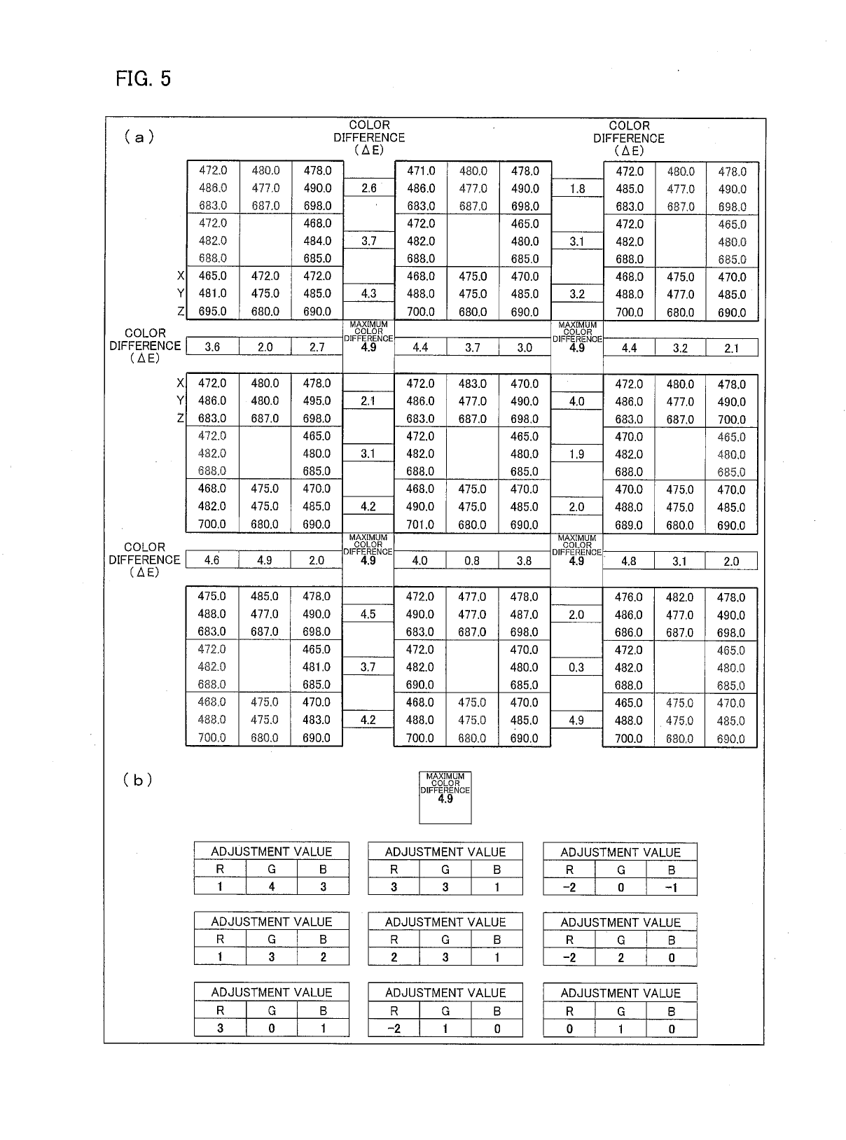

In a case where the number of displays is larger than 2×2, i.e., the number of displays is, for example, 3×3, a maximum color difference may be displayed, as illustrated in (a) of FIG. 5, in each center space of each group of 2×2 displays arranged in correspondence with the examples of FIG. 3 and FIG. 4 in which a value of the maximum color difference is displayed in the center space surrounded by the 2×2 displays constituting a multi-display. Further, 3×3 displays require many adjustment values. As such, as illustrated in (b) of FIG. 5, 3×3 blocks in which adjustment values of each display are inputted may be provided in a region different from a region provided with blocks in which XYZ values of each display are displayed. The layout of 3×3 blocks into which adjustment values are inputted corresponds to the layout of blocks in which XYZ values of each display are displayed. Further, a value of a maximum color difference may be displayed in the vicinity of a group of blocks into which adjustment values are inputted (positions for setting adjustment values) as illustrated in an example of (b) of FIG. 5.

(a) and (b) of FIG. 5 are diagrams, in a situation where the number of displays is larger than 2×2, illustrating an example of an image showing (i) measurement results of the displays, (ii) color differences and a maximum color difference both of which are calculated on the basis of the measurement results, and (iii) adjustment values of the displays.

An adjustment method is performed such that RGB values of the individual displays are adjusted so that the maximum color difference is minimized. In a manual calibration, a user enters adjustment values by using a mouse and a keyboard (input section) both of which are provided in the system control section 40 (see FIG. 1).

The following describes a method in which adjustment values are automatically inputted and a maximum color difference is minimized. For example, two displays providing a maximum color difference (in the example of FIG. 3, the upper left display and the lower left display) are subjected to adjustment. For the two displays, RGB adjustment values are inputted, and ΔXYZ values (second adjustment value in a device independent color space) corresponding to the inputted RGB adjustment values are then obtained by the transformation matrix. Next, the obtained XYZ values are added to the whole display (separate regions obtained by the division) to which the adjustment values are inputted, so as to correct measurement results. Subsequently, a color difference is calculated on the basis of the corrected measurement results (calculation section).

At this time, the adjustment values are inputted to the two displays subject to adjustment (in the example of FIG. 3, the upper left display and the lower left display). Correction of the measurement results of these two displays changes color differences between the two displays to be adjusted and their other adjacent displays. As such, color differences between (a) the two displays in which their measurement results have been corrected by the adjustment and (b) their adjacent displays are all calculated (in the example of FIG. 3, color differences between the upper left display and an upper right display and color differences between the lower left display and the lower right display).

In a case where the color differences obtained by the recalculation are equal to or larger than the maximum color difference (in the example of FIG. 3, 10.5), a further adjustment is performed with another RGB adjustment values changed from the original RGB adjustment values. On the other hand, in a case where the color differences obtained by the recalculation are smaller than the maximum color difference, the inputted adjustment values are regarded as having been set with respect to the two displays subject to adjustment (in the example of FIG. 3, the upper left display and the lower left display). Subsequently, certain two displays providing a maximum color difference among all color differences at that time are targeted for adjustment. Then, an adjustment is newly made with respect to the certain two displays by using the same method as the one described above. The adjustment values of the displays and the calculated maximum color difference are stored in such a manner that both of them are associated with each other (second storage section).

The above process is carried out until the maximum color difference is minimized and saturated. Then, adjustment values by which the maximum color difference is minimized are set to each display (an adjustment section).

The above process allows the adjustment values by which the maximum color difference is minimized to be calculated for the two displays subject to adjustment. However, adjustments of other displays by using the adjustment values obtained for the above two displays may lead to an increase in color difference, resulting in a condition different from the above condition in which the maximum color difference is minimized. As such, it is preferable that (i) the adjustment values by which the maximum color difference is minimized and (ii) a value of the maximum color difference are stored so that the stored values can be referenced to in making a final judgment.

The above method allows calculating a measurement result for each separate region of a display, and it is therefore possible to determine, on an xy chromaticity diagram, which color a color to be calibrated is deviated toward. Therefore, on the basis of a result of the determination, it is possible to set adjustment values including signs. Note that the above method may be replaced by a method of inputting RGB adjustment values obtained by any varying combinations of R, G, B values so as to find a condition in which a maximum color difference is minimized.

In a case where an adjustment is manually made, any adjustment values are entered, and the process is then carried out a predetermined number of times to obtain a maximum color difference. Then, a condition in which the maximum color difference is minimized is selected. In order to check whether adjustment values obtained by the adjustment practically achieve color reproduction as expected, a color measurement may be performed again in a state that the set adjustment values are reflected, to observe a practical measurement result. If the practical measurement result includes a deviation, an adjustment may be made again.

Even in the manual adjustment, the measurement result corrected based on the entered adjustment value is preferably indicated by a difference in hue. This facilitates determining, on an xy chromaticity diagram, which color a color to be calibrated is deviated toward. Besides, it is possible to set, on the basis of a result of the determination, adjustment values including signs. Meanwhile, if the indication of the differences in hue with each change of the adjustment value may require much time to complete the adjustment, the indication of the differences in hue may carried out only after an adjustment value having been entered by a user is finally determined. In this case, only the XYZ values (values obtained by calculation) or the color differences are displayed during the adjustment.

Note that the arrangement (configuration) of displays is not limited to 2×2, and can be alternatively 3×5. Further alternatively, displays may be arranged in such a manner that each one side of two displays is in contact with one side of one other display. Such irregularly arranged displays are also adjustable since boundaries of the two displays are positioned on the one side of the one other display.

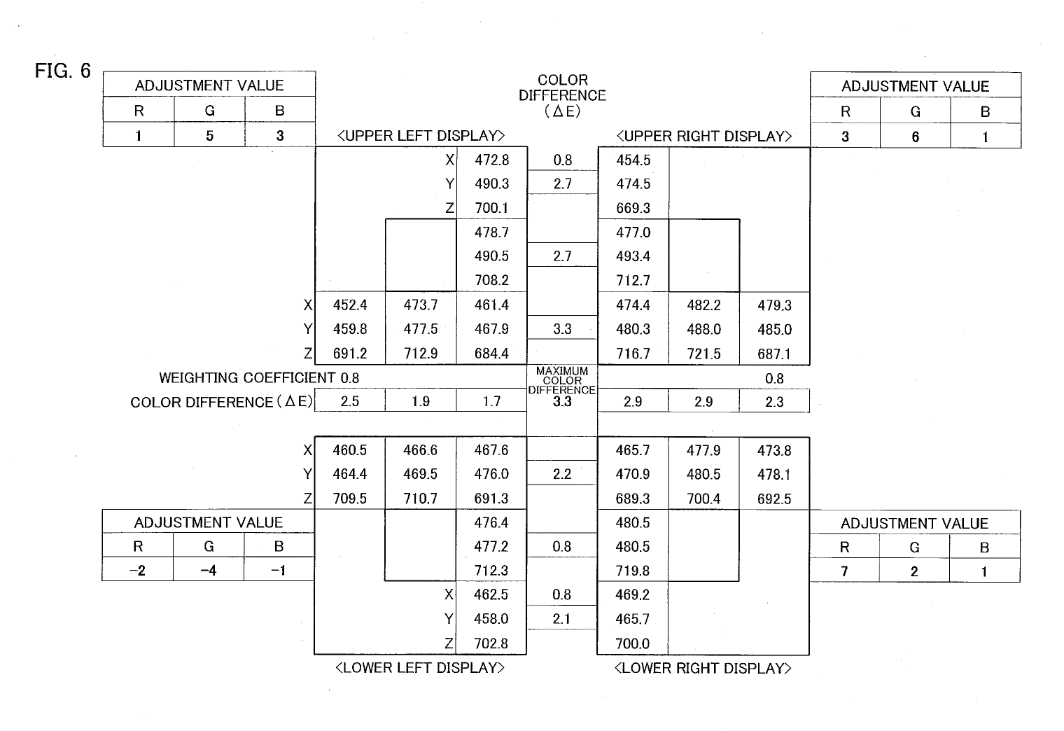

In performing calibration of a multi-display, in a case where an adjustment is performed based on the premise that importance is placed to a color difference at a center of an arrangement of a plurality of displays while less importance is placed to color differences at edge portions of the arrangement, a weighting adjustment may be performed in a state that weighing for the color differences at edge portions of the multi-display is done. FIG. 6 illustrates an example in which a color difference is calculated by setting, to 0.8, a weighting coefficient of a color difference at edge portions of 2×2 displays. FIG. 6 is a diagram illustrating a process in which the calculation section 46 (see FIG. 11) of the system control section 40 (see FIG. 1) described later corrects measurement results on the basis of the inputted adjustment value, and then obtains color differences and a maximum color difference by calculation, on the basis of the post-correction measurement results, in a state that weighing for the color differences at edge portions of a multi-display is done.

### (Explanation of Transformation Matrix Represented by Formula 1)

The following explains a method of obtaining the transformation matrix represented by Formula 1. A RGB value as specified in the CIERGB system which is a colorimetric system defined by the CIE, or an RGB value as specified in the sRGB system which is an international standard can be transformed by a single 3×3 matrix. However, a RGB value shown on a display cannot be transformed by a single matrix. Practically, the transformation matrix needs to be changed according to a displayed color. This is because a RGB value depends on characteristics of a material used for a display (in the case of a liquid crystal display, a spectrum of a light source, filter characteristics, and other characteristics).

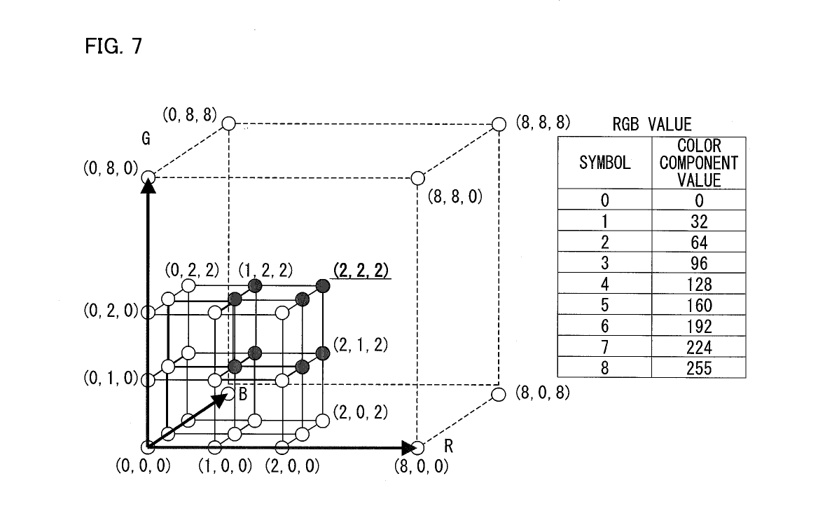

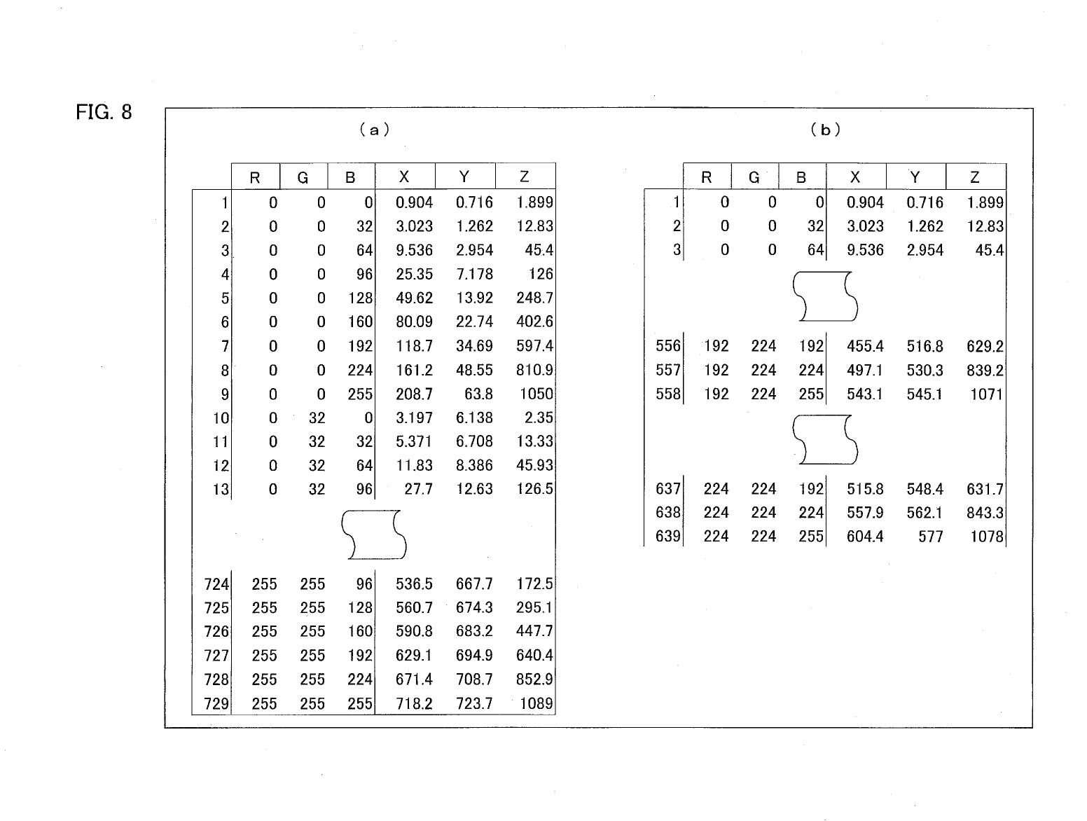

Primarily, there is no problem if (X, Y, Z) values can be measured with respect to all RGB values ((0,0,0) to (255,255,255)). However, it is practically impossible to perform measurements of all of the RGB values (For example, if RGB is represented by eight bits, it is necessary to perform measurements on about 16.7 million colors.). As such, nine representative values, for example, {0, 32, 64, 96, 128, 160, 192, 224, 255} are selected for each R, G, B, and RGB values obtained by any varying combinations of the selected values are designated as representative values. Then, measurements on the representative values, which are 9×9×9=729 colors illustrated in FIG. 7, are performed. Then, result of the measurements are summarized in a lookup table (LUT) as illustrated in (a) of FIG. 8, wherein the LUT represent relationships between the RGB values and the XYZ values.

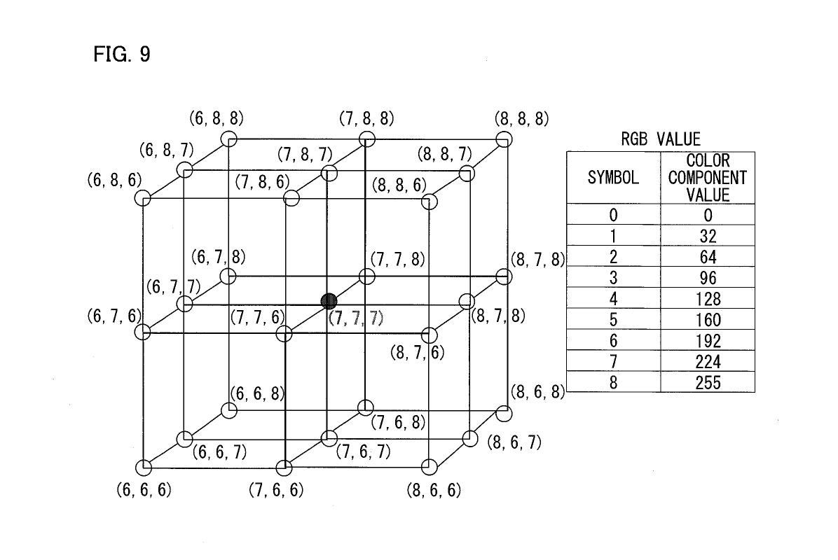

As in an example illustrated in FIG. 9, a transformation matrix when a RGB value (224,224,224) is shown (represented as (7,7,7) in FIG. 9; If a color corresponding to the RGB value (224,224,224) is shown on a display during a measurement for calibration, this RGB value is regarded as a “reference value”) is obtained by using neighboring RGB values, e.g. (192,224,224) (represented as (6,7,7) in FIG. 9) and (224,255,224) (represented as (7,8,7) in FIG. 9), and XYZ values corresponding to the RGB values.

Practically, a variation is to be obtained. As such, the transformation matrix is obtained by using Formula 2. Formula 2 is a relational formula between ΔRGB values, which are differences from the reference value, and ΔXYZ values.

$$\begin{matrix}[ Math . 2 ] & \\ ( \begin{matrix}Δ X 1 & Δ X 2 & Δ X 3 \\ Δ Y 1 & Δ Y 2 & Δ Y 3 \\ Δ Z 1 & Δ Z 2 & Δ Z 3\end{matrix} ) = ( \begin{matrix}a & b & c \\ d & e & f \\ g & h & i\end{matrix} ) \cdot ( \begin{matrix}Δ R 1 & Δ R 2 & Δ R 3 \\ Δ G 1 & Δ G 2 & Δ G 3 \\ Δ B 1 & Δ B 2 & Δ B 3\end{matrix} ) & Formula 2\end{matrix}$$

Referring to (b) of FIG. 8, (ΔR1,ΔG1,ΔB1) is (224,224,224)−(192,224,224)=(32,0,0), and (ΔX1, ΔY1, ΔZ1) is (557.9,562.1,843.3)−(497.1,530.3,839.2)=(60.8,31.8,4.1), which is a difference between XYZ values corresponding to the RGB values as used.

In Formula 2, three points (ΔX1, ΔY1, ΔZ1), (ΔX2, ΔY2, ΔZ2), and (ΔX3, ΔY3, ΔZ3) are used. These values are all substituted into Formula 2, and both sides of Formula 2 are postmultiplied by “Inverse matrix 1” represented by Formula 3:

$$\begin{matrix}[ Math . 3 ] & \\ {( \begin{matrix}Δ R 1 & Δ R 2 & Δ R 3 \\ Δ G 1 & Δ G 2 & Δ G 3 \\ Δ B 1 & Δ B 2 & Δ B 3\end{matrix} )}^{- 1} Inverse matrix 1 & Formula 3\end{matrix}$$

As a result, elements (a to i) are obtained by “Transformation matrix 1” of the following Formula 4:

$$\begin{matrix}[ Math . 4 ] & \\ ( \begin{matrix}a & b & c \\ d & e & f \\ g & h & i\end{matrix} ) = ( \begin{matrix}Δ X 1 & Δ X 2 & Δ X 3 \\ Δ Y 1 & Δ Y 2 & Δ Y 3 \\ Δ Z 1 & Δ Z 2 & Δ Z 3\end{matrix} ) \cdot ( \begin{matrix}Δ R 1 & Δ R 2 & Δ R 3 \\ Δ G 1 & Δ G 2 & Δ G 3 \\ Δ B 1 & Δ B 2 & Δ B 3\end{matrix} ) Transformation matrix 1 & Formula 4 \\ [ Math . 5 ] & \\ ( \begin{matrix}Δ X \\ Δ Y \\ Δ Z\end{matrix} ) = ( \begin{matrix}a & b & c \\ d & e & f \\ g & h & i\end{matrix} ) \cdot ( \begin{matrix}Δ R \\ Δ G \\ Δ B\end{matrix} ) & Formula 5\end{matrix}$$

By using Formula 1 representing the transformation matrix, ΔX, ΔY, ΔZ when R is changed by 1 (ΔR=1) (G and B are unchanged; ΔG=0, ΔB=0) are obtained.

As is apparent from FIG. 9, there are actually 26 neighboring points around the reference value. From these 26 neighboring points, appropriate three points need to be selected to obtain the transformation matrix. The obtained transformation matrix can be checked for accuracy as follows. That is, as for the remaining 23 points (=26−3), measurement values corresponding to RGB values are calculated by using the obtained transformation matrix. Subsequently, the measurement values obtained by the calculation are compared with actually measured values. Then, a transformation matrix minimizing differences between the measurement values and the actually measured values is obtained. Alternatively, color measurements may be actually performed using another color which is replaced with a given color to be adjusted, so that on the basis of the result of the color measurements, a transformation matrix providing a color closest to the used color can be obtained.

Usually, one color is display during calibration and is defined as, for example, a RGB value (224,224,224). As such, transformation matrixes required for individual models of displays are obtained beforehand. Only when a user wishes to perform adjustment while displaying his/her desired color, the transformation matrix is obtained on the basis of data corresponding to 729 colors in the LUT. Further, the use of one color for display is basically good enough for the measurement and adjustment. Alternatively, a plurality of colors may be displayed for the measurement and adjustment in a case where there are other colors for checking or any particular colors to be used.

### (Examples of Other Transformation Matrixes)

In a case where the 3×3 transformation matrix is not good enough, a 3×9 transformation matrix represented by Formula 6 below may be employed because accuracy is increased by using a matrix including a higher order term (herein, a second-order term).

$$\begin{matrix}[ Math . 6 ] & \\ ( \begin{matrix}X 1 & X 2 & X 3 & X 4 & X 5 & X 6 & X 7 & X 8 & X 9 \\ Y 1 & Y 2 & Y 3 & Y 4 & Y 5 & Y 6 & Y 7 & Y 8 & Y 9 \\ Z 1 & Z 2 & Z 3 & Z 4 & Z 5 & Z 1 & Z 7 & Z 8 & Z 9\end{matrix} ) = ( \begin{matrix}a 1 & a 2 & a 3 & a 4 & a 5 & a 6 & a 7 & a 8 & a 9 \\ b 1 & b 2 & b 3 & b 4 & b 5 & b 6 & b 7 & b 8 & b 9 \\ c 1 & c 2 & c 3 & c 4 & c 5 & c 6 & c 7 & c 8 & c 9\end{matrix} ) \cdot ( \begin{matrix}R 1 & R 2 & R 3 & R 4 & R 5 & R 6 & R 7 & R 8 & R 9 \\ G 1 & G 2 & G 3 & G 4 & G 5 & G 6 & G 7 & G 8 & G 9 \\ B 1 & B 2 & B 3 & B 4 & B 5 & B 6 & B 7 & B 8 & B 9 \\ R 1 \hat{} 2 & R 2 \hat{} 2 & R 3 \hat{} 2 & R 4 \hat{} 2 & R 5 \hat{} 2 & R 6 \hat{} 2 & R 7 \hat{} 2 & R 8 \hat{} 2 & R 9 \hat{} 2 \\ G 1 \hat{} 2 & G 2 \hat{} 2 & G 3 \hat{} 2 & G 4 \hat{} 2 & G 5 \hat{} 2 & G 6 \hat{} 2 & G 7 \hat{} 2 & G 8 \hat{} 2 & G 9 \hat{} 2 \\ B 1 \hat{} 2 & B 2 \hat{} 2 & B 3 \hat{} 2 & B 4 \hat{} 2 & B 5 \hat{} 2 & B 6 \hat{} 2 & B 7 \hat{} 2 & B 8 \hat{} 2 & B 9 \hat{} 2 \\ R 1 G 1 & R 2 G 2 & R 3 G 3 & R 4 G 4 & R 5 G 5 & R 6 G 6 & R 7 G 7 & R 8 G 8 & R 9 G 9 \\ G 1 B 1 & G 2 B 2 & G 3 B 3 & G 4 B 4 & G 5 B 5 & G 6 B 6 & G 7 B 7 & G 8 B 8 & G 9 B 9 \\ B 1 R 1 & B 2 R 2 & B 3 R 3 & B 4 R 4 & B 5 R 5 & B 6 R 6 & B 7 R 7 & B 8 R 8 & B 9 R 9\end{matrix} ) & Formula 6\end{matrix}$$

In this case, a point to be referenced to (a point used only when the transformation matrix is obtained) can be obtained by using nine points, i.e. (R1,G1,B1) to (R9,G9,B9) (measurement values at this time are (X1,Y1,Z1) to (X9,Y9,Z9)).

In Formula 6, the symbol “Δ” is omitted. However, since it is necessary to obtain variations, “ΔX1”, “ΔR1”, and others are actually calculated by using Formula 6, based on the concept of obtaining differences from the reference point, in the same manner as in Formula 2. The 3×9 transformation matrix represented by Formula 6 can be obtained by using nine pieces of data in which (ΔX, ΔY, ΔZ) and (ΔR, ΔG, ΔB) are associated with each other.

Thus, the 3×9 transformation matrix is obtained with reference to any nine points out of 26 points (=3×3×3−1) around the reference point. The 3×9 transformation matrix is therefore more accurate than the 3×3 matrix. However, it cannot be said that the 3×9 transformation matrix causes no errors. The transformation matrix in which a relationship between RGB values and XYZ values are established is obtained with reference to any nine points, but it is not clear whether the transformation matrix obtained with reference to the nine points can be applied to other 17 (=26−9) points.

As such, the following process using the obtained transformation matrix is required. That is, values for remaining 17 (=26−9) points are obtained by using the obtained transformation matrix represented by Formula 6.

Then, the obtained values are compared with values obtained with reference to the LUT of the 729 colors. If an error(s) is found in a result of the comparison, it is necessary to obtain another transformation matrix which can decreases a margin of the error(s). Specifically, the above process is performed in the following steps: (1) to (6):

(1) Any nine points are selected and used to obtain the transformation matrix (a1 to c9) by Formula 6 (the symbol “Δ” is omitted) above.

(2) As for the other 17 points, differences (ΔR, ΔG, and ΔB) between R′, G′, B′ values of the 17 points and the R, G, B values of the reference point are calculated, and right side values of Formula 7 below are obtained by using the transformation matrix (a1 to c9) calculated by Formula 6 above.

(3) As for the other 17 points, differences (ΔX, ΔY, and ΔZ) between X′, Y′, Z′ values of the 17 points and the X, Y, Z values of the reference point are calculated with reference to the LUT for the 729 colors (left side values of Formula 7 below are obtained).

(4) Differences between the values obtained in the step (2) and the values obtained in the step (3) are calculated as an error.

(5) Another “combination of nine points” (nine points selected from the 26 points), which is different from the above combination of nine points”, is selected, and the steps (1) to (4) are performed.

(6) The above process is repeatedly performed, and a transformation matrix which minimizes the errors obtained in the step (4) is then obtained.

$$\begin{matrix}[ Math . 7 ] & \\ ( \begin{matrix}Δ X \\ Δ Y \\ Δ Z\end{matrix} ) = ( \begin{matrix}a 1 & a 2 & a 3 & a 4 & a 5 & a 6 & a 7 & a 8 & a 9 \\ b 1 & b 2 & b 3 & b 4 & b 5 & b 6 & b 7 & b 8 & b 9 \\ c 1 & c 2 & c 3 & c 4 & c 5 & c 6 & c 7 & c 8 & c 9\end{matrix} ) \cdot ( \begin{matrix}Δ R \\ Δ G \\ Δ B \\ Δ R \hat{} 2 \\ Δ G \hat{} 2 \\ Δ B \hat{} 2 \\ Δ R \cdot Δ G \\ Δ G \cdot Δ B \\ Δ B \cdot Δ R\end{matrix} ) & Formula 7\end{matrix}$$

In this manner, calculation using the matrix including a high order term may be performed to increase accuracy. However, even by the 3×3 matrix can enhance accuracy if an adjustment range is segmented into smaller ranges and different transformation matrixes are used for the individual ranges.

The above description has discussed the case where the RGB adjustment value can take a positive value or a negative value with respect to the reference point as shown in FIG. 9, and a range of the RGB value from (192,192,192) to (255, 255, 255) with respect to the reference point (224,224,224) is covered by a single transformation matrix.

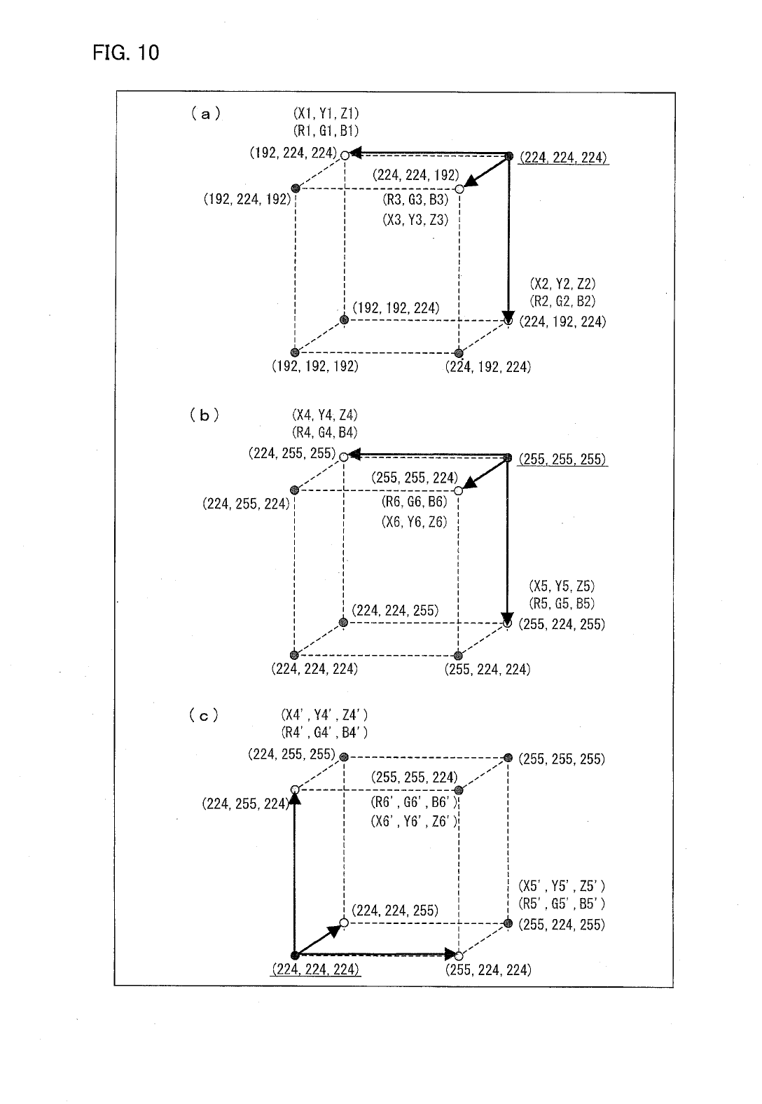

Alternatively, different transformation matrixes may be used for the individual adjustment ranges. Specifically, a transformation matrix based on the reference point (224,224,224) is used as shown in (a) of FIG. 10 only in a case where an adjustment is to be performed in a range from (192,192,192) to (224,224,224) with respect to the reference point (224,224,224), i.e. an adjustment is to be performed such that the adjustment value is in a range from (−32,−32,−32) to (0,0,0). On the other hand, a transformation matrix obtained in a block shown in (b) of FIG. 10 is used in a case where the RGB values are to be all adjusted positively based on the reference point (224,224,224), i.e. in a case where the adjustment is to be performed such that the adjustment value is in a range from (0,0,0) to (32,32,32).

Furthermore, in a case where the RGB values are to be all adjusted positively based on the reference point (224,224,224), accuracy is further increased by using a transformation matrix in which three points to be referenced to are (255,224,224), (224,255,224), and (224,224,255) as shown in (c) of FIG. 10. The reason for this is as follows.

It has been described above that, due to various factors, a relationship between RGB values and XYZ values (transformation matrix) is not determined uniquely depending on the RGB values. However, there are no significant differences between transformation matrixes. In a case where much the same RGB values, like (224,224,224) and (224,224,225), are transformed by using the same transformation matrix, XYZ values obtained by calculation are much the same as actually measured values. In addition, as for the adjustment value during the calibration, an extremely large adjustment value is not usually inputted. Therefore, in a case where the reference value is (224,224,224), the transformation matrix obtained by the method, as in (c) of FIG. 10, using values to be referenced to which values are close to (224,224,224) is better in performance than the transformation matrix obtained in (b) of FIG. 10.

### (Configuration of Calibration System)

FIG. 1 is a block diagram illustrating a configuration of the calibration system of the present embodiment. A calibration system 1 includes a signal processing apparatus (image displaying apparatus) 10, a system control section (computer) 40, and a measurement section 50.

The signal processing apparatus 10 includes a signal processing section 12 and a display section 14 of the multi-display. The signal processing section 12 includes an interface 20, a control section 25, a power source unit 30, an audio output section 31, and an operating section 32.

The interface 20 includes: a Digital Visual Interface (DVI) terminal 21 and a High-Definition multimedia Interface® (HDMI) terminal 22, both of which carry out serial communications with the system control section 40 by a Transition Minimized Differential Signaling (TMDS); and a LAN terminal 23 and an RS-232C terminal 24 both of which are used for communications based on a communication protocol such as Transmission Control Protocol (TCP) or User Datagram Protocol (UDP).

The interface 20 sends/receives data to/from an external apparatus(es) connected with the DVI terminal 21, the HDMI terminal 22, or the LAN terminal 23 in accordance with an instruction from an overall control section 26, which will be described later, of the control section 25. The interface 20 may be further provided with a USB terminal and an IEEE1394 terminal.

The control section 25 includes the overall control section 26 which comprehensively controls each block of the signal processing apparatus 10, an image signal processing section 27, an audio signal processing section 28, and a panel controller 29.

The image signal processing section 27 subjects image data received, via the interface 20, from the system control section 40 to predetermined processing to generate image data (an image signal) for showing an image on a plurality of displays of the display section 14.

The audio signal processing section 28, upon receipt of audio data via the interface 20, subjects the audio data to predetermined processing to generate an audio signal.

The panel controller 29 controls the display section 14 so that the display section 14 displays thereon an image of image data outputted from the image signal processing section 27.

The power source unit 30 controls power supplied from an external entity. The overall control section 26 causes the power source unit 30 to provide or shut off a power supply, in accordance with an operation instruction received from a power source switch (not illustrated) of the operating section 32. In a case where the operation instruction received from the power source switch is an operation instruction of switching power on, a power supply is provided to the signal processing apparatus 10. On the other hand, in a case where the operation instruction received from the power source switch is an operation instruction of switching power off, a power supply to the signal processing apparatus 10 is shut off.

The display section 14 is, for example, a liquid crystal display (LCD) device and a plasma display panel and displays an image corresponding to image data outputted by the image signal processing section. The present embodiment provides a multi-display configuration in which four displays are provided in 2×2 arrangement, but the arrangement of the multi-display is not limited to the 2×2 arrangement.

The audio output section 31 outputs an audio signal generated by the audio signal processing section 28 under an instruction from the overall control section 26.

The operating section 32 includes at least a power supply switch (not shown) and a selector switch (not shown). The power supply switch is a switch for inputting an operation instruction for switching the power source of the signal processing apparatus 10 from on to off and vice versa. The selector switch is a switch for inputting an operation instruction to designate a single display from multiple displays constituting the display section 14. In response to activations of the power supply switch and the selector switch, the operating section 32 outputs, to the overall control section 26, an operation instruction corresponding to each of the switches.

The above description takes an example where the operating section 32 provided in the signal processing apparatus 10. Alternatively, the operating section 32 may be provided in a remote controller (not illustrated) which can wirelessly communicate with the signal processing section 10 so that the remote controller can transmit the operation instruction corresponding to each of the switches to the signal processing apparatus 10. In this case, a communication medium required for the remote controller to communicate with the signal processing apparatus 10 may be infrared light or electromagnetic waves. Further alternatively, the system control section 40 may control the operation instruction corresponding to each of the switches.

Further, the signal processing apparatus 10 may be connected with a tuner and a TV antenna so that an image corresponding to a broadcasting signal received by the tuner and TV antenna can be displayed on the display section 14.

A measuring section 50 includes a color-measurement device 50a provided with a USB terminal used for a USB connection with the system control section 40. In response to a measurement request signal from the system control section 40, the measuring section 50 performs color measurement on the display section 14, and then transmits a result of the measurement to the system control section 40.

The color-measurement device 50a may be either one of a contact type color-measurement device and a contactless type color-measurement device. Examples of the contact type color-measurement device include Spyder series from Datacolor Corporation and ColorMunki series, i1 series, and the like from X-Rite Inc. Examples of the contactless type color-measurement device include a spectroradiometer (CS-200, etc.) and a two-dimensional luminance meter (CA-2000, etc.), both of which are manufactured by Konica Minolta, and a luminance measuring apparatus (UA-1000A, etc.), which is manufactured by TOPCON CORPORATION.

In order to perform color measurement on a display, a calibration tool (application software) is first installed on the system control section 40, and the color-measurement device 50a is USB-connected to the system control section 40 so that the color-measurement device 50a is used. The calibration tool causes the system control section 40 to have a calibration processing section, which will be described later, established in the system control section 40. Further, the calibration tool can cause the display section 14 to output an image, make an adjustment for image setting, and perform a measurement together with the color-measurement device 50a as connected. Accordingly, a desired color shown on any of the displays of the display section 14 can be measured by the color-measurement device 50a while the color-measurement device 50a is made in contact with that display, calculation based on a result of the measurement can be made by using an application software, and adjustment for a suitable image setting can be made based on a result of the calculation.

FIG. 11 is a block diagram of a calibration processing section for performing calibration. A calibration processing section 42 includes a display image generation section 44, an input section 45, a calculation section 46, a selection section 47, and an adjustment section 49.

The display image generation section 44 generates a color calibration image for calibrating a color of each of the displays of the display section 14, which color calibration image is to be shown on each of the displays. In other words, the display image generation section 44 generates, for each of the displays, an image indicating a plurality of calibration images which are predetermined in correspondence with a color subject to adjustment, and such image is shown on each display.

The display image generation section 44 generates an image indicating hue differences which are measurement results obtained by the color-measurement device 50a having measured the color of the calibration images displayed on a plurality of regions of each of the displays, wherein the measurement results are results of the measurement on at least mutually bordering regions of the displays out of all of the regions of the plurality of displays, and the hue differences are indicated by colors so as to correspond to the plurality of displays arranged in the display section. Such an image is used for manual calibration.

In a case where there occurs color non-uniformity, the display image generation section 44 generates the image indicating a state of the color non-uniformity for each of the separate regions of a single display. In a case where calibration is manually performed, the display image generation section 44 generates an image schematically indicating the arrangement of the displays and indicating measurement results and color differences of the individual regions of the displays (generates images similar to the drawings of FIGS. 3 and 4). The image also indicates color differences obtained on the basis of the measurement results of the bordering regions of the displays and indicates a maximum color difference in a highlighted manner.

The input section 45 accepts adjustment values determined on a display by display basis and received in the form of RGB values, at the time of adjustment of the displays constituting the display section 14. In the manual calibration, the input section 45 corresponds to a keyboard and mouse of the system control section 40. The display image generation section 44 displays a screen for inputting an adjustment value, which screen allows an input of a numerical value with use of the keyboard and mouse of the system control section 40.

The calculation section (correction section) 46 obtains color differences between adjacent displays on the basis of the measurement results in correspondence to locations of the plurality of displays, and then determines a maximum color difference from the obtained color differences. Further, the calculation section 46 determines post-correction measurement results which are obtained by correction based on the adjustment values inputted by the input section 45. Specifically, the calculation section 46 reads, from the storage section 48 described later, a transformation matrix corresponding to the color subject to adjustment, and then converts the adjustment values inputted by the input section 45 into the XYZ values by using the read transformation matrix, thereby obtaining post-correction measurement results. Still further, the calculation section 46 determines (i) color differences between adjacent displays on the basis of the post-correction measurement results and (ii) a maximum color difference. The calculation section 46 causes the storage section (second storage section) 48 to store the adjustment values and the maximum color difference in such a state that the adjustment values are associated with the maximum color difference.

The adjustment section 49 sets, with use of the adjustment value inputted by the input section 45, a color to be shown on each of the displays constituting the display section 14. The adjustment section 49 sets the adjustment value by which the maximum color difference is minimized, with reference to the maximum color difference stored in the storage section 48.

During the calibration, the selection section 47 selects only one of (a) measurement results making the maximum color difference, which is determined from the color differences between adjacent displays, equal to or above a predetermined threshold value and (b) the post-correction measurement results. The display image generation section 44 generates an image indicating at least one of the followings: (i) the measurement result selected by the selection section 47 or the post-correction measurement result; (ii) the adjustment value inputted by the input section 45; (iii) the measurement results of each of the displays (indicated by hue differences or by XYZ values) which measurement results are stored in the storage section 48; (iv) the measurement results of each of the displays (indicated by hue differences or by XYZ values) which measurement results are obtained by the correction performed by the correction section 46; (v) the color differences between the adjacent displays; and (vi) the maximum color difference. Provision of the selection section 47 arranged as above allows only measurement results making the maximum color difference equal to or above the threshold value (e.g. “2,”, “3”, or other value) to be selected for a judgment on whether or not to perform adjustment. This realizes an efficient calibration.

The storage section (first storage section, second storage section) 48 stores calibration image data, the measurement results of the individual displays, data obtained by adjustment based on the adjustment values (post-adjustment data of the regions of the individual displays, post-adjustment color difference, and post-adjustment maximum color difference), and the transformation matrix required for the adjustment. The storage section 48 may double as a storage section provided in the system control section 40 or may be provided independently from the storage section provided in the system control section 40.

### (Procedure of Calibration Process)

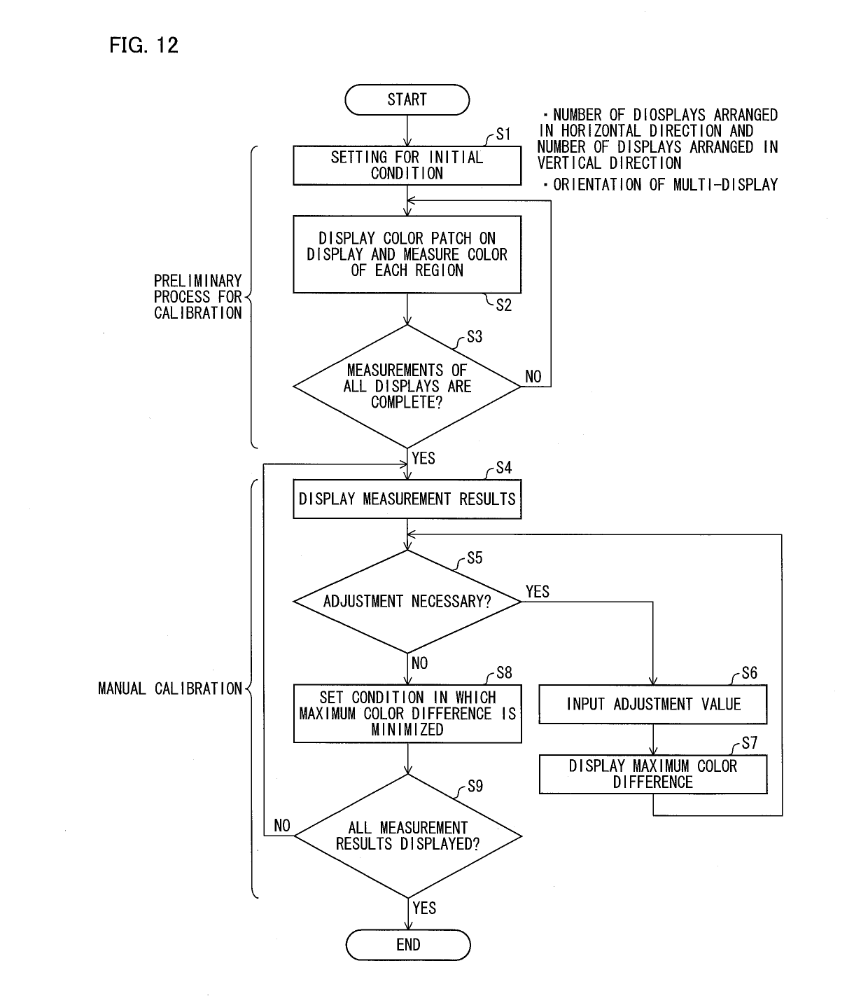

FIG. 12 is a flow chart illustrating a procedure of manual calibration process. First, settings are made by inputting initial conditions such as the number of horizontally-arranged displays to be calibrated, the number of vertically-arranged displays to be calibrated, and an orientation of the multi-display (a portrait orientation or a landscape orientation) (S1). Subsequently, the display image generation section 44 provided in the system control section 40 generates, for each of the displays of the display section 14 in the signal processing apparatus 10 which displays are to be sequentially subjected to measurement, a plurality of calibration images which are determined in correspondence with a color to be adjusted. On the basis of the generated calibration images, the control section 25 causes the color to be adjusted to be sequentially displayed on a plurality of separate in-plane portions of the display. Before each measurement, the contact type color-measurement device 50a is moved to a portion where the color to be adjusted is displayed and then placed at that portion. The color-measurement device used here may be a contactless type color-measurement device if influence of, for example, outside light can be eliminated during the movement and placement of the color-measurement device 50a. The above process is performed on all of the displays constituting the multi-display of the display section 14 (S2, S3). Data obtained by the measurements are managed by the storage section (first storage section) 48 in such a manner that information about, for example, displays, measurement areas, displayed colors, measurement values, and set values are recognizable. This completes a preliminary process necessary for performing the calibration.

In S2 where measurement is performed on the color to be adjusted which color is displayed on the screen, it is preferable that only an area where the color-measurement device 50a is to be located is viewed in a different way so that such an area is recognizable. For example, an area where the color-measurement device is to be located is indicated by a “cross” in red, while the background is indicated by black, so that the color-measurement device 50a is allowed to be located at an intersection portion of the cross. Accordingly, even in a case where an area of the in-plane separate regions is relatively large, the color-measurement device 50a can be located at the same position regardless of who measures.

The color indication is performed in the following manner. First, the cross in red is displayed in the area where the color-measurement device 50a is to be located while the background is displayed in black, so that the color-measurement device 50a can be located at an appropriate position. Thereafter, a color for checking the location of the color-measurement device is displayed for checking on whether or not the color-measurement device 50a is located at a right position, in which state, an actual measurement is performed. At this time, a color used for color measurement is not immediately displayed, and measurement is performed in a state that, for example, a cyan color is displayed, in order to check on whether or not a measurement value is a “measurement value falling within a predetermined range” corresponding to the cyan color. This, however, remains a possibility that the color-measurement device 50a happens to measure an object in cyan color. As such, another measurement is subsequently performed in a state that other color (e.g. a magenta color) different from the cyan color is displayed. Similarly, if a result of the measurement successfully corresponds to the magenta color, it is determined that the color-measurement device 50a is located in a right place. Thereafter, a color to be actually measured is displayed for measurement.

The above process is performed on all of the portions to be measured (e.g. in the example of (b) of FIG. 4, 3×3=9 portions). The color-measurement device 50a may be performed in any order. Starting with an upper left part, the color-measurement device 50a is moved to a right-hand side across a row. When the measurement at a right edge part is finished, the color-measurement device 50a is moved down by one row to a leftmost part in that row, and the color-measurement device 50a is then moved to the right-hand side across that row. When the measurement of the lower right part is finished, the measurement is completed, and the measurement results are stored in the storage section 48. This operation is performed on all of the displays constituting the multi-display of the display section 14. Data obtained by the measurements are managed by the storage section 48 in such a manner that information about, for example, displays, portions having been measured, displayed colors, measurement values, and set values are recognizable. This makes it possible to obtain an optimum image setting.

For each type of display, a lookup table (LUT) is prepared beforehand. The LUT stores therein measurement values (representative values) which are obtained by measurements performed beforehand on 729 points (9×9×9=729) out of points corresponding to RGB values from (0,0,0) to (255,255,255), wherein the 729 points are obtained by any varying combinations of nine representative values {0, 32, 64, 96, 128, 160, 192, 224, 255} selected for each R, G, B (The LUT stores therein RGB values and their corresponding XYZ values which are the measurement values.). As for the color to be adjusted, a recommended color which is prepared beforehand (e.g. (R,G,B)=(224,224,224)) may be displayed. In some cases, prime importance may be placed on color reproduction of a symbol color of a company. In this situation, the color to be adjusted (reference color) is specified before the measurement so that a transformation matrix with respect to the specified color can be set.

Normally, when a light color (color close to white) out of the colors whose R, G, and B have identical values, i.e. the colors covering from “black (0,0,0), through gray, to white (255,255,255)” is displayed and adjusted in RGB contrast, other colors also change in amount commensurate with the adjustment value with respect to the displayed light color. Therefore, it is preferable to perform the measurement and adjustment with use of the recommended color. The adjustment value is obtained by using the transformation matrix and the RGB data of the displayed color, which are obtained in a manner as described above, measurement data of the displays actually arranged.

By using ΔRGB to ΔXYZ transformation, (1) ΔX, ΔY, and ΔZ when R is changed by 1, (2) ΔX, ΔY, and ΔZ when G is changed by 1, and (3) ΔX, ΔY, and ΔZ when B is changed by 1 are obtained. Thus, it is possible to predict measurement values obtained by subjecting measured values of a display to adjustment with use of a predetermined adjustment value. Thus, in a case where a plurality of displays are arranged, adjusting each of the displays in accordance with, for example, a policy of minimizing color differences leads to an optimum calibration.

Next, the display image generation section 44 shows the measurement result on any one of the displays in the display section 14 (S4). Note that if the system control section 40 includes another display section separately from the display section 14, the measurement result may be shown on that display section.

In a case where there occurs color non-uniformity, the display image generation section 44 and the control section 25 cause the state of the color non-uniformity to be displayed on each of the separate regions of a single display. In a case where calibration is performed manually, the display image generation section 44 and the control section 25 schematically displays the arrangement of the displays, as illustrated in, for example, FIG. 3, and displays measurement results of the regions of each of the displays, and displays an image indicating color differences. The image also indicates color differences obtained on the basis of the measurement results of the bordering regions of the displays and indicates a maximum color difference in a highlighted manner (Note that since the measurement results indicated as XYZ values are difficult to understand, the measurement results are actually indicated as, for example, differences in hue from the color to be adjusted rather than as the XYZ values.).

In S5, it is determined whether or not an adjustment is necessary. Specifically, in a case where a calculation is to be performed until a maximum color difference is minimized, the determination is made based on whether or not the maximum color difference is at the minimum (in other words, based on whether the maximum color difference is saturated to an extent that it is impossible to further minimize the maximum color difference). Further, in a case where the number of times the calculation is to be performed or a calculation time is prescribed, the determination is performed based on whether the prescribed condition is met.

If it is determined that the adjustment is necessary, the process proceeds to S6 and S7, then the adjustment value is inputted, the measurement result is corrected based on the inputted adjustment value. On the basis of a post-correction measurement result, color differences between the bordering portions of the displays are calculated, and a maximum color difference. Subsequently, the color differences and the maximum color difference are displayed, and the process then returns to S5.

On the other hand, if it is determined in S5 that the adjustment is not necessary, the process proceeds to S8. In S8, an adjustment value which satisfies the condition that it minimizes the maximum color difference is read from the storage section 48, and the read adjustment value is then set to its corresponding display for color adjustment. The process from S4 to S8 is performed on all of the measurement results.

In other embodiment in accordance with the present invention, in a case where there occurs color non-uniformity, its corresponding color is displayed. The state of the color non-uniformity is expressed by a shift (a shift to blue, a shift to red, etc.) from a calibration color (displayed color). For example, if the displayed color is white (or a greyish color), a color deviated from white (or a greyish color) in an xy chromaticity diagram is displayed. The adjustment value is set based on the measurement result, the measurement value is corrected, and the maximum color difference is calculated. This process is performed repeatedly to perform a calibration. The occurrence of color non-uniformity is displayed on each of the separate regions of a single display. Adjustment of the RGB values is achieved by performing a calibration with use of only a single color. Accordingly, RGB values corresponding to other colors can be adjusted.

Further, in a case where calibration is automatically performed, all possible adjustment values can be inputted, irrespective of a value of the maximum color difference, to find an adjustment value satisfying the condition that it minimizes the maximum color difference. Alternatively, the following operation may be performed. That is, measurement results are obtained with respect to calibration images being displayed. Thereafter, only when the maximum color difference obtained on the basis of the measurement results is equal to or above a predetermined value (e.g. “2” or “3”), an adjustment value is inputted to perform calculation for determining whether or not the adjustment value satisfies the condition that it minimizes the maximum color difference. In this case, at the completion of the measurement, a user may be prompted to input an instruction as to whether to perform calibration. The user who has been prompted to input the instruction judges as to whether to perform calibration, from the state of the color non-uniformity.

The calculation may be performed repeatedly until the maximum color difference is minimized (until the maximum color difference is saturated). Alternatively, the number of times calculation is to be performed or a calculation time may be prescribed, so that an adjustment value satisfying the condition that it minimizes the maximum color difference may be extracted from adjustment values obtained under the prescribed condition.

### (Storage Medium and Program)

According to the present invention, a computer-readable storage medium storing therein a program for causing a computer to execute can be arranged such that a system control device such as a computer performs calculation based on data obtained by measurement of each display by means of a color-measurement device, in order to obtain an optimum image setting, and then transmits a value corresponding to the optimum image setting to a display apparatus through the computer-readable storage medium, so that the optimum image setting can be performed on the display apparatus.

As a result, a storage medium storing therein a program code (an execution type program, an intermediate code program, and a source program) for executing the above process can be provided in a freely portable manner.

Note that, in the present embodiment, the storage medium may be a program medium such as a memory, e.g. ROM, itself to be processed by a microcomputer, or may be a program medium readable when the storage medium is inserted into a program reading device provided as an external storage device.

In either case, a stored program may be configured such that a microprocessor accesses the program to execute it. Alternatively, in either case, a system may be employed in which the program code is read, the read program code is downloaded on a program storage area of a microcomputer, and the program is executed. A program for downloading is stored beforehand in a main body apparatus.

The program medium is a recording medium configured to be separable from a main body, and examples of the recording medium encompass a non-transitory tangible medium such as, for example, tapes including an electromagnetic tape and a cassette tape, a magnetic disk including a Floppy® disk/hard disk, a disc including an optical disc such as a CD-ROM/MO/MD/DVD/CD-R, a card including an IC card (including a memory card)/optical card, a semiconductor memory including a mask ROM/EPROM/EEPROM®/flash ROM, or a logic circuit including a Programmable Logic Device (PLD) and a Field Programmable Gate Array (FPGA).

The present embodiment provides a system configured to be connectable with a communication network including Internet. Therefore, the program medium may be a medium fluidly carrying a program code so that the program code is downloaded from the communication network. Note that in a case where the program is downloaded from the communication network as described above, the programs for downloading may be stored beforehand in the main body apparatus or may be installed from a separate recording medium.

The communication network is not limited to any specific network as long as it can transmit the program code. Examples of the communication network include Internet, an intranet, an extranet, a LAN, an ISDN, a VAN, a CATV communication network, a Virtual Private Network, a telephone network, a mobile communication network, and a satellite communication network. Further, a transmission medium constituting the communication network is not limited to a transmission medium of a specific structure or of a specific type as long as the transmission medium can transmit the program code. Examples of the transmission medium include (i) wired transmission media such as IEEE1394, a USB, a power-line carrier, a cable TV line, a telephone line, and Asymmetric Digital Subscriber Line (ADSL) and (ii) wireless transmission media such as IrDA and remote control using infrared light, Bluetooth®, IEEE802.11, High Data Rate (HDR), Near Field Communication (NFC), Digital Living Network Alliance® (DLNA), a mobile telephone network, a satellite circuit, and a terrestrial digital network.

It should be noted that the present invention can also be implemented in the form of a computer data signal embedded in a carrier wave which is embodied by an electronic transmission of the program code.

### CONCLUSION

A calibration system for a multi-display, in accordance with one aspect of the present invention is a calibration system for performing color adjustment on each of a plurality of displays constituting the multi-display, the calibration system including: a display image generation section configured to generate a color calibration image for calibrating a color of each of the displays; a first storage section configured to store therein measurement results, the measurement results being results of measurements of colors of a plurality of regions of each of the displays on which the color calibration image generated by the display image generation section is being displayed; an input section configured to accept, for the individual displays, color first adjustment values corresponding to the respective displays; a correction section configured to read, from the first storage section, the measurement results of the displays, and then correct the read measurement results with use of the corresponding color first adjustment values inputted by the input section; a calculation section configured to obtain color differences between the displays adjacent to each other, with correspondence to an arrangement of the displays, on a basis of measurement results of bordering regions of the displays out of the measurement results stored in the first storage section or out of, if any, post-correction measurement results obtained by correction performed by the correction section, and then determine a maximum color difference from the obtained color differences; a second storage section configured to store therein the maximum color difference determined by the calculation section in such a manner that the maximum color difference is associated with the corresponding first adjustment values used for the correction performed by the correction section; and an adjustment section configured to read, from the second storage section, the first adjustment values which minimize the maximum color difference, and then set, for the individual displays, the read first adjustment values to perform color adjustment on the displays.

According to the above configuration, the display image generation section generates a color calibration image for calibrating a color of each of the displays. The generated color calibration image is displayed on each of the displays. Colors of a plurality of regions of each of the displays are measured, so that the measurement results of the regions of each of the displays are obtained, and the obtained measurement results are stored in the first storage section.

The input section accepts, for the individual displays, color first adjustment values corresponding to the respective displays. The correction section reads, from the first storage section, the measurement results of the displays, and then correct the read measurement results with use of the corresponding color first adjustment values inputted by the input section. This makes it possible to obtain measurement results reflecting the first adjustment value, without having to perform color adjustment based on the first adjustment value and then perform measurement again.

The calculation section obtains color differences between the displays adjacent to each other, with correspondence to an arrangement of the displays, on a basis of the measurement results stored in the first storage section or, if any, post-correction measurement results obtained by correction performed by the correction section, and then determines a maximum color difference from the obtained color differences.

The second storage section stores therein the maximum color difference determined by the calculation section in such a manner that the maximum color difference is associated with its corresponding first adjustment values used for the correction performed by the correction section. The adjustment section reads, from the second storage section, first adjustment values which minimize the maximum color difference, and then set, for the individual displays, the read first adjustment values to perform color adjustment on the displays.

In this manner, color adjustment is performed on each of the displays, by using the maximum color difference as an index, on the basis of the actual measurement results and the post-correction measurement results obtained by reflecting the first adjustment value on the measurement results. Therefore, it is possible to perform calibration even when it is not clear to what extent an adjustment should be performed.

The calibration system in accordance with one aspect of the present invention may be arranged such that the first adjustment value is an inputted value correcting a pixel value corresponding to a color to be adjusted, the adjustment section converts the first adjustment value into a second adjustment value in a device independent color space with a matrix transformation, and a matrix used for the matrix transformation is set for each of characteristics of the displays.

In obtaining the adjustment value, a relationship between RGB values (adjustment values) and XYZ values (measurement values) is determined by a matrix transformation. The matrix is set for each of characteristics of the displays because the matrix varies depending on specifications of the displays. This makes it possible to increase accuracy of calibration. Conversely, the same matrix can be used for displays having the same specification. This is because the same tendency is basically obtained even though there is some difference between characteristics of the displays.

The calibration system in accordance with one aspect of the present invention may be arranged such that the matrix is set for each color.

A matrix used for transformation of a displayed color (e.g. black, white, gray, and the like) shown on the display during an adjustment can also be used for transformation of a color close to the displayed color. However, the same matrix cannot be used for different colors. This because a color shown on a display is device-dependent due to characteristics of a display, such as characteristic of a light source (luminescence spectrum) and wavelength characteristic of a filter (in a case of a liquid crystal display). As such, different matrixes need to be used for different displayed colors. Thus, calibration using a plurality of colors can be performed with a higher degree of accuracy by using different matrixes corresponding to the colors.

The calibration system in accordance with one aspect of the present invention may be arranged such that the display image generation section further generates an image indicating the first adjustment value inputted by the input section and at least one of the followings: the measurement results of each of the displays, which measurement results are stored in the first storage section; the post-correction measurement results of each of the displays, which measurement results are obtained by the correction performed by the correction section; the color differences between the adjacent displays; and the maximum color difference.

A manual calibration (e.g. adjustment of slight color non-uniformity) can be easily performed by showing the first adjustment value inputted by the input section and at least one of the followings: the measurement results of each of the displays, which measurement results are stored in the first storage section; the post-correction measurement results of each of the displays, which measurement results are obtained by the correction performed by the correction section; the color differences between the adjacent displays; and the maximum color difference.

The calibration system in accordance with one aspect of the present invention may be arranged such that the calibration system further includes a selection section configured to select only measurement results making the maximum color difference, which is determined from the color differences between the adjacent displays, equal to or above a predetermined threshold value, and the display image generation section generates, on a basis of the measurement results selected by the selection section, an image indicating the first adjustment value inputted by the input section and at least one of the followings: the measurement results of each of the displays, which measurement results are stored in the first storage section; the post-correction measurement results of each of the displays, which measurement results are obtained by the correction performed by the correction section; the color differences between the adjacent displays; and the maximum color difference.

This allows only measurement results making the maximum color difference equal to or above the threshold value (e.g. “3” or other value) to be selected for a judgment on whether or not to perform adjustment, thus realizing an efficient calibration.

The calibration system in accordance with one aspect of the present invention may be arranged such that as the first adjustment values, RGB values are inputted.

A value obtained by measuring a color shown on a display is represented by a color in a CIE standard color space (a color of CIEXYZ, CIEL*a*b*; a device independent color). Therefore, it is difficult to directly adjust this value. In contrast, as the first adjustment values, RGB values are inputted. This is sensuously recognizable and realizes an easy adjustment.

The calibration system in accordance with one aspect of the present invention is a non-transitory computer-readable storage medium storing therein a program for causing a computer to function as the calibration system in accordance with one aspect of the present invention, the program causing the computer to serve as the individual sections of the calibration system.

The program read from a storage medium allows implementation of calibration for easily adjusting the multi-display by using the maximum color difference as an index.

The present invention is not limited to the descriptions of the foregoing embodiments, but can be altered within the scope of the claims. An embodiment derived from a proper combination of technical sections disclosed in different embodiments is also encompassed in the technical scope of the present invention.

### REFERENCE SIGNS LIST

1 Calibration system
10 Signal processing apparatus
12 Signal processing section
14 Display section (multi-display)
25 Control section
40 System control section
42 Calibration processing section
44 Display image generation section
45 Input section
46 Calculation section (calculation section, correction section)
47 Selection section
48 Storage section (first storage section, second storage section)
49 Adjustment section
50 Measuring section
50a Color-measurement device

1. A calibration system for a multi-display, the calibration system being a calibration system for performing color adjustment on each of a plurality of displays constituting the multi-display,
the calibration system comprising:
a display image generation section configured to generate a color calibration image for calibrating a color of each of the displays;
a first storage section configured to store therein measurement results, the measurement results being results of measurements of colors of a plurality of regions of each of the displays on which the color calibration image generated by the display image generation section is being displayed;
an input section configured to accept, for the individual displays, color first adjustment values corresponding to the respective displays;
a correction section configured to read, from the first storage section, the measurement results of the displays, and then correct the read measurement results with use of the corresponding color first adjustment values inputted by the input section;
a calculation section configured to obtain color differences between the displays adjacent to each other, with correspondence to an arrangement of the displays, on a basis of measurement results of bordering regions of the displays out of the measurement results stored in the first storage section or out of, if any, post-correction measurement results obtained by correction performed by the correction section, and then determine a maximum color difference from the obtained color differences;
a second storage section configured to store therein the maximum color difference determined by the calculation section in such a manner that the maximum color difference is associated with the corresponding first adjustment values used for the correction performed by the correction section; and
an adjustment section configured to read, from the second storage section, the first adjustment values which minimize the maximum color difference, and then set, for the individual displays, the read first adjustment values to perform color adjustment on the displays.

2. The calibration system according to claim 1, wherein
the first adjustment value is an inputted value correcting a pixel value corresponding to a color to be adjusted,
the adjustment section converts the first adjustment value into a second adjustment value in a device independent color space with a matrix transformation, and
a matrix used for the matrix transformation is set for each of characteristics of the displays.

3. The calibration system according to claim 2, wherein
the matrix is set for each color to be adjusted.

4. The calibration system according to claim 1, wherein
the display image generation section further generates an image indicating the first adjustment value inputted by the input section and at least one of the followings:
the measurement results of each of the displays, which measurement results are stored in the first storage section;
the post-correction measurement results of each of the displays, which measurement results are obtained by the correction performed by the correction section;
the color differences between the adjacent displays; and
the maximum color difference.

5. The calibration system according to claim 4, further comprising:
a selection section configured to select only measurement results making the maximum color difference, which is determined from the color differences between the adjacent displays, equal to or above a predetermined threshold value,
the display image generation section generating, on a basis of the measurement results selected by the selection section, an image indicating the first adjustment value inputted by the input section and at least one of the followings:
the measurement results of each of the displays, which measurement results are stored in the first storage section;
the post-correction measurement results of each of the displays, which measurement results are obtained by the correction performed by the correction section;
the color differences between the adjacent displays; and
the maximum color difference.

6. The calibration system according to claim 4, wherein
as the first adjustment values, RGB values are inputted.

7. The calibration system according to claim 5, wherein
as the first adjustment values, RGB values are inputted.

8. A non-transitory computer-readable storage medium storing therein a program for causing a computer to function as the calibration system recited in claim 1, the program causing the computer to serve as the individual sections of the calibration system.
